(19) United States
(12) Patent Application Publication
(10) Pub. No.: US 2026/0319601 A1
(43) Pub. Date: Oct. 15, 2026

(54) TOUCHPAD DEVICE

(71) Applicant: TPK Glass Solutions (Xiamen) Inc., Xiamen (CN)

(72) Inventors: Cai-Jin YE, Xiamen City (CN); Wei-Yi LIN, Taoyuan City (TW)

(21) Appl. No.: 19/577,516

(22) Filed: Mar. 25, 2026

(30) Foreign Application Priority Data
Apr. 11, 2025 (CN) 202510457259.7

(51) Int. Cl. G06F 3/0354; G06F 3/01

(52) U.S. Cl. CPC G06F 3/03547; G06F 3/016

(57) ABSTRACT

A touchpad device includes a first substrate and a second substrate. The first substrate is provided with a touch sensing element and a first capacitive coupling electrode layer. The first capacitive coupling electrode layer is provided with a first induction layer and a second induction layer surrounding the first induction layer. The second substrate is provided with a second capacitive coupling electrode layer. The second capacitive coupling electrode layer includes a first protrusion and a second protrusion surrounding the first protrusion. The first protrusion is higher than the second protrusion. The first protrusion corresponds to the first induction layer. The second protrusion corresponds to the second induction layer.

### CROSS-REFERENCE TO RELATED APPLICATION

This application claims priority to China Patent Application 202510457259.7, filed Apr. 11, 2025, which is incorporated herein by reference.

### BACKGROUND OF THE DISCLOSURE

### Field of Disclosure

The present disclosure relates to a touchpad device.

### Description of Prior Art

The current development trend of touchpad devices is the advancement from merely the touch function to an integration of touch, force sensing, and tactile feedback. A touchpad device of the prior art installs a force sensor on an elastic component (such as a metal bracket) and mounts the elastic component to a touch printed circuit board, for example, as described in China Patent Application No. 107025017B. However, the disadvantages of these devices of the prior art include a large number of elements, complex assembly processes, higher overall costs, and generally larger thickness. The sensitivity of force sensors is also insufficient.

Therefore, to provide a touchpad device that can solve the aforementioned problems is among the problems that the industry invests its research and development resources in to solve.

### SUMMARY

In view of this, one objective of the present disclosure is to provide a touchpad device that can solve the aforementioned problems.

To achieve the aforementioned objective, according to an embodiment of the present disclosure, a touchpad device comprises a first substrate and a second substrate. The first substrate is configured with a touch sensing element and a first capacitive coupling electrode layer. The first capacitive coupling electrode layer is configured with a first induction layer and a second induction layer surrounding the first induction layer. The second substrate is configured with a second capacitive coupling electrode layer. The second capacitive coupling electrode layer includes a first protrusion and a second protrusion surrounding the first protrusion. The first protrusion is higher than the second protrusion. The first protrusion corresponds to the first induction layer. The second protrusion corresponds to the second induction layer.

In one or several embodiments of the present disclosure, the first protrusion is disposed opposite to the first induction layer in an arrangement direction of the first capacitive coupling electrode layer and the second capacitive coupling electrode layer; and the second protrusion is disposed opposite to the second induction layer in the arrangement direction.

In one or several embodiments of the present disclosure, the touchpad device further comprises a processing unit. The processing unit is configured to acquire a first capacitance based on an electrical induction between the first protrusion and the first induction layer, and configured to acquire a second capacitance based on an electrical induction between the second protrusion and the second induction layer.

In one or several embodiments of the present disclosure, the touchpad device further comprises a force feedback module. The force feedback module is disposed on the side of the first capacitive coupling electrode layer away from the first substrate. The processing unit is further configured to drive the force feedback module while the first capacitance changes to saturation and the second capacitance continues changing.

In one or several embodiments of the present disclosure, the processing unit is further configured to drive the force feedback module when the first capacitance and the second capacitance are changing simultaneously.

In one or several embodiments of the present disclosure, the processing unit is further configured not to drive the force feedback module when the first capacitance changes to saturation and the second capacitance does not continue changing.

In one or several embodiments of the present disclosure, the touchpad device further comprises a support bracket and a support member. The support bracket is mounted to the second substrate. The support member is disposed between and supports the support bracket and the first capacitive coupling electrode layer.

In one or several embodiments of the present disclosure, the second substrate has a recess on the side close to the support bracket. The recess is disposed opposite to the support member and a part of the support bracket in an arrangement direction of the first capacitive coupling electrode layer and the second capacitive coupling electrode layer.

In one or several embodiments of the present disclosure, the support bracket comprises at least one hollow portion. The at least one hollow portion is disposed opposite to the recess in the arrangement direction.

In one or several embodiments of the present disclosure, the first protrusion and the first induction layer have a distance therebetween in the arrangement direction; the recess has a depth in the arrangement direction; and the distance is larger than the depth.

In one or several embodiments of the present disclosure, the first protrusion has a first height in the arrangement direction; the support member has a second height in the arrangement direction; and the second height is larger than the first height.

In one or several embodiments of the present disclosure, the touch sensing element and the first capacitive coupling electrode layer are different conductor layers embedded in a circuit board.

In summary, compared to the conventional designs of having a single induction layer, the touchpad device of the present disclosure adopts a design of having surrounding induction layers on the first capacitive coupling electrode layer (that is, a first induction layer and a second induction layer surrounding the first induction layer). Therefore, the present disclosure can detect the touched position and pressure distribution more effectively, which enhances the touch sensing accuracy. Furthermore, the design of having surrounding induction layers helps to distinguish the touches on different positions, detect multi-finger touches, or prevent accidental touches. The touchpad device of the present disclosure also adopts a stepped protrusion structure design applied on the second capacitive coupling electrode layer (that is, the first protrusion and the second protrusion having different heights). Therefore, the present disclosure can distinguish different levels of presses and precisely detect presses by fingers even under the condition of multi-finger touches or accidental palm touches.

The aforementioned statements are used to explain problems that can be solved by the present disclosure, the technical means for solving the problems, and the effect thereof. The present disclosure will be explained from the detailed descriptions given herein below by way of embodiments with reference to the accompanying figures.

### BRIEF DESCRIPTION OF THE FIGURES

To better understand the aforementioned objective and other objectives, novel features, advantages, and embodiments of the present disclosure, relevant figures are provided as follows.

FIG. 1 is a schematic figure of an electronic device according to an embodiment of the present disclosure.

FIG. 2 is a cross-sectional view schematic figure along the cutting line 2-2 of the electronic device of FIG. 1.

FIG. 3 is a partial top-view figure of the casing part of the host computer of FIG. 1.

FIG. 4 is a bottom-view figure of some elements of the touchpad device of FIG. 2.

FIG. 5 is a block figure of functions of some elements of the touchpad device according to an embodiment of the present disclosure.

### DETAILED DESCRIPTION

A plurality of embodiments of the present disclosure will be disclosed below with reference to figures. For the purpose of clear illustration, many details in practice will be described together with the following descriptions. However, these detailed descriptions in practice are for illustration only and shall not be interpreted to limit the scope, applicability, or configuration of the present disclosure in any way. That is, in several embodiments of the present disclosure, these details in practice are not necessarily required. Furthermore, for the purpose of simplifying figures, some structures and components of the prior art shown in the figures will be illustrated schematically.

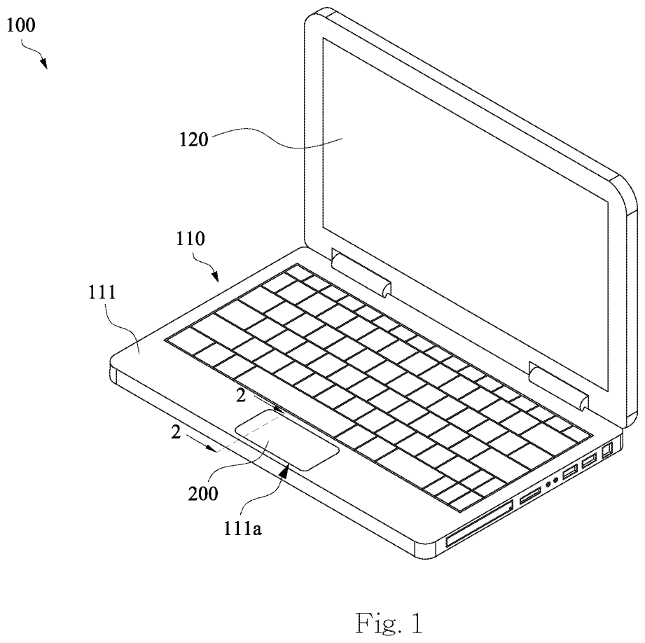

Please refer to FIG. 1, which is a schematic figure of an electronic device 100 according to an embodiment of the present disclosure. In the embodiment illustrated in FIG. 1, the electronic device 100 comprises a host computer 110, a display 120, and a touchpad device 200. The touchpad device 200 is disposed within the host computer 110, and is exposed to the outside from the recessed groove 111a of the casing part 111 of the host computer 110. The touchpad device 200 is an input device of the host computer 110 and is disposed therewithin; however, the present disclosure is not limited thereto. Furthermore, the touchpad device 200 is a rectangular area, consisting of a length and a width, wherein the width can be adjusted according to the design of different models, and the size is not limited to that shown in FIG. 1. In actual applications, the touchpad device 200 can be an electronic product using a touchpad as an input or operational interface (such as, personal digital assistant, keyboard having a touchpad, etc.). In other words, the concept of the touchpad device 200 of the present disclosure can be applied to any electronic product that uses a touchpad as an input or operational interface. Details of the touchpad device 200, including the structure and functions of some elements thereof, and connections and the operation relationship among these elements, will be provided below.

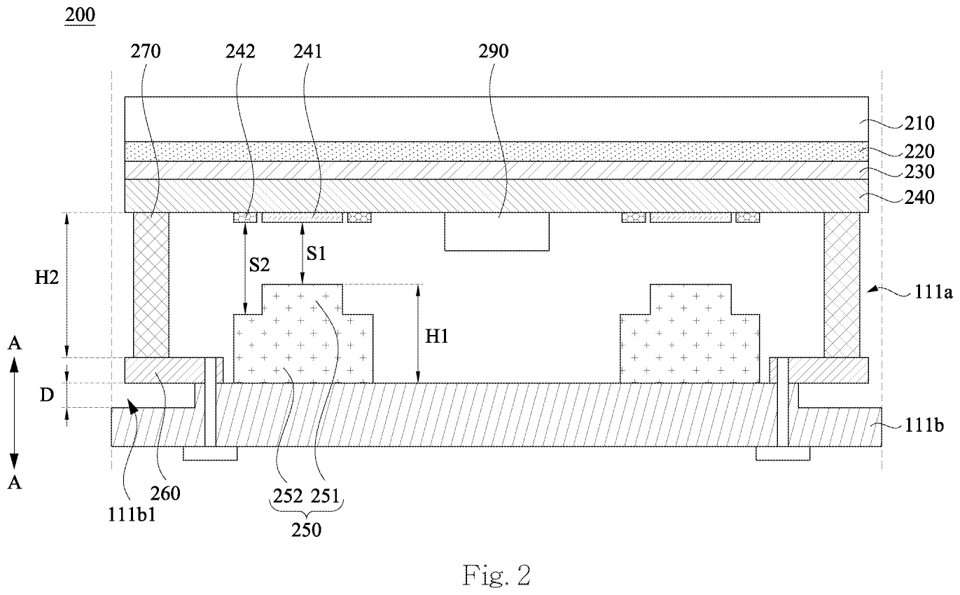

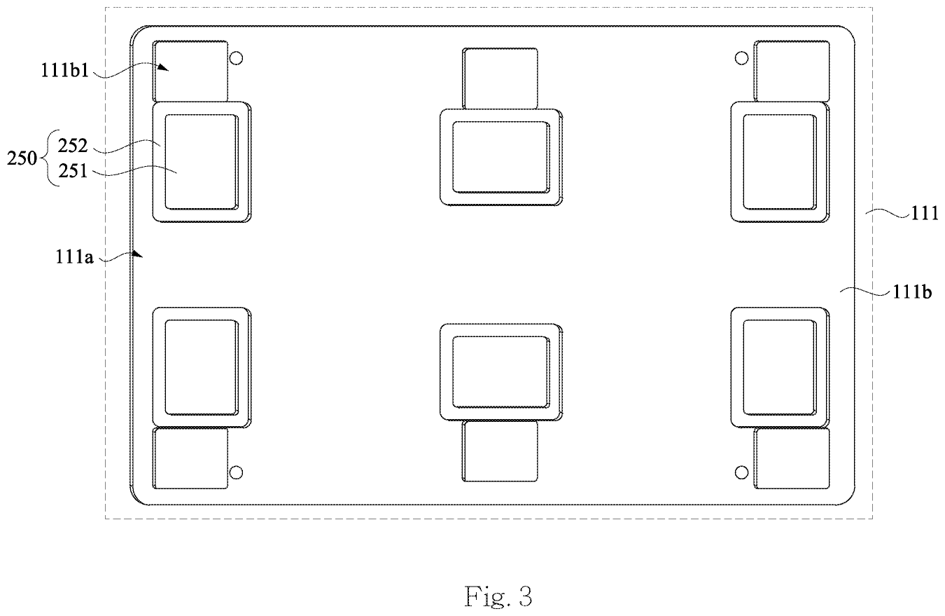

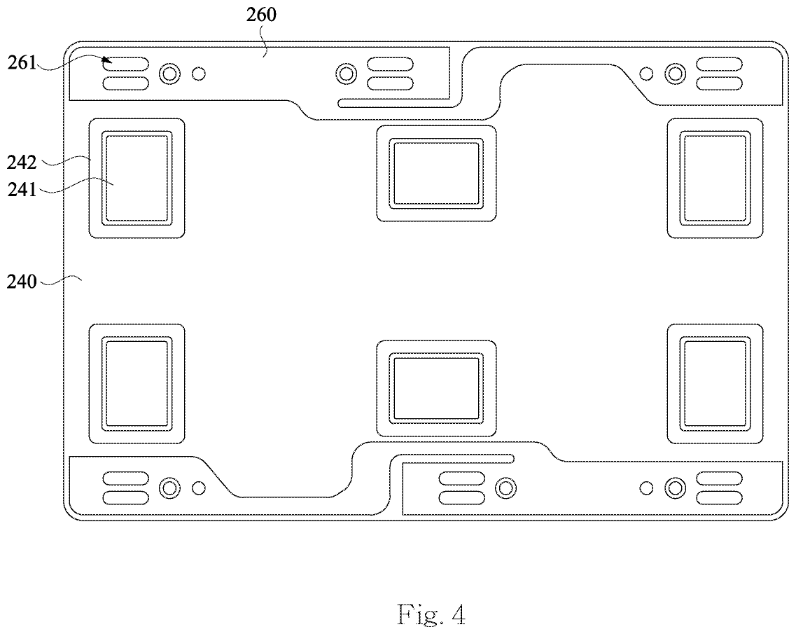

Please refer to FIG. 2, FIG. 3, and FIG. 4. FIG. 2 is a cross-sectional view schematic figure along the cutting line 2-2 of the electronic device 100 of FIG. 1. FIG. 3 is a partial top-view figure of the casing part 111 of the host computer 110 of FIG. 1. FIG. 4 is a bottom-view figure of some elements of the touchpad device 200 of FIG. 2. As shown in FIG. 2 to FIG. 4, in the embodiment, the touchpad device 200 comprises a first substrate 210 and a second substrate 111b. The first substrate 210 is configured with a touch sensing element 230 and a first capacitive coupling electrode layer 240. The second substrate 111b is configured with a second capacitive coupling electrode layer 250. More specifically, the touchpad device 200 further comprises a bonding layer 220. The first substrate 210 is connected with the touch sensing element 230 through the bonding layer 220. The first capacitive coupling electrode layer 240 is disposed on one side of the touch sensing element 230 away from the first substrate 210. Furthermore, the touchpad device 200 further comprises a support bracket 260 and a support member 270. The support bracket 260 is mounted to the second substrate 111b. The support member 270 is disposed between and supports the support bracket 260 and the first capacitive coupling electrode layer 240. Please note that the second substrate 111b is located in the recessed groove 111a of the casing part 111 of the host computer 110. When the user presses the first substrate 210, the support bracket 260 and the support member 270 connected between the first capacitive coupling electrode layer 240 and the second substrate 111b are deformed by force, forcing the assembly of the first substrate 210, the bonding layer 220, the touch sensing element 230, and the first capacitive coupling electrode layer 240 to shift downward towards the second substrate 111b. In several embodiments, the touch sensing element 230 and the first capacitive coupling electrode layer 240 may be integrated within the same circuit board (for example, two layers of a printed circuit board). In other words, the touch sensing element 230 and the first capacitive coupling electrode layer 240 may be different conductor layers embedded in a circuit board, whereas the touch sensing element 230 and the first capacitive coupling electrode layer 240 are, for example, two layers within a printed circuit board (PCB) comprising multiple routing layers (for example, 4 layers). The following paragraphs will introduce the first induction layer 241 and the second induction layer 242 that are integrated and disposed below the printed circuit board, which enables thinning the overall touchpad device 200.

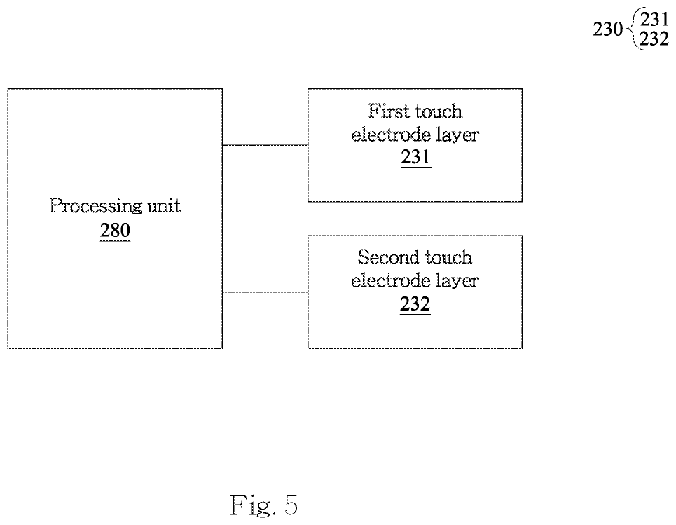

Please refer to FIG. 5, which is a block figure of functions of some elements of the touchpad device 200 according to an embodiment of the present disclosure. As shown in FIG. 5, in the embodiment, the touch sensing element 230 comprises a first touch electrode layer 231 and a second touch electrode layer 232. The touchpad device 200 further comprises a processing unit 280. The processing unit 280 is electrically connected with the first touch electrode layer 231 and the second touch electrode layer 232, and the processing unit 280 is configured to produce detection capacitance signals corresponding to the touches on the first substrate 210 by users detected by the first touch electrode layer 231 and the second touch electrode layer 232. Such capacitance signals may be used to determine the touch position.

As shown in FIG. 2 to FIG. 4, in the embodiment, the first capacitive coupling electrode layer 240 is configured with a first induction layer 241 and a second induction layer 242 surrounding the first induction layer 241. The first induction layer 241 and the second induction layer 242 are disposed on the side of the first capacitive coupling electrode layer 240 facing the second substrate 111b. In addition, the second capacitive coupling electrode layer 250 is disposed on the side of the second substrate 111b facing the first capacitive coupling electrode layer 240, and comprises a first protrusion 251 and a second protrusion 252 surrounding the first protrusion 251. The first protrusion 251 is higher than the second protrusion 252. The first protrusion 251 corresponds to the first induction layer 241. The second protrusion 252 corresponds to the second induction layer 242. The first induction layer 241 and the second induction layer 242 may have an electrode design in any pattern form that induces capacitance variation. For example, the induction coil layer (not shown in the figure) may be in the form of an open coil or encapsulated coil. However, the present disclosure is not limited thereto.

More specifically, the first protrusion 251 is disposed opposite to the first induction layer 241 in an arrangement direction A of the first capacitive coupling electrode layer 240 and the second capacitive coupling electrode layer 250. The second protrusion 252 is disposed opposite to the second induction layer 242 in the arrangement direction A. By clearly restricting the relative position of the protrusion and the induction layer, effective coupling of the electric fields may be ensured, thus enhancing the sensitivity and accuracy of touch sensing. Such an explicit mapping allows the touchpad device 200 to more precisely sense the touch position and pressure distribution. The distance S1 between the first protrusion 251 and the first induction layer 241 is different from the distance S2 between the second protrusion 252 and the second induction layer 242. Therefore, the first capacitance between the first induction layer 241 and the first protrusion 251 is also different from the second capacitance between the second induction layer 242 and the second protrusion 252.

The touchpad device 200 of the embodiment adopts a design of having surrounding induction layers on the first capacitive coupling electrode layer 240 (that is, the second induction layer 242 surrounds the first induction layer 241). Therefore, compared to the conventional designs of having a single induction layer, the present disclosure can detect the touch position and pressure distribution more effectively, which enhances the touch sensing accuracy. Furthermore, the design of having surrounding induction layers helps to distinguish presses in different positions, detect multi-finger touches, or prevent accidental touches.

Since the second capacitive coupling electrode layer 250 adopts a stepped protrusion structure design (that is, the first protrusion 251 and the second protrusion 252 have different heights), the touchpad device 200 of the present disclosure can distinguish different levels of presses and precisely detect presses by fingers even under the condition of multi-finger touches or accidental touches.

As shown in FIG. 2, in the embodiment, the touchpad device 200 further comprises a force feedback module 290. The force feedback module 290 is disposed on the side of the first capacitive coupling electrode layer 240 away from the first substrate 210. The processing unit 280 is further configured to acquire a first capacitance based on the electrical induction between the first protrusion 251 and the first induction layer 241, and the processing unit 280 is configured to acquire a second capacitance based on the electrical induction between the second protrusion 252 and the second induction layer 242. By obtaining the first capacitance and the second capacitance separately, the processing unit 280 may analyze the touch events more accurately, for example, to determine the pressure scale and the touch scenario based on the capacitance variation. In addition, the processing unit 280 is further configured to drive the force feedback module 290 based on the first capacitance and the second capacitance. For example, when the user is pressing the touchpad device 200 of the present disclosure, there are several touch scenarios as listed in Table 1.

TABLE 1

| No. | Touch Scenario | State of Force Feedback Module |
|---|---|---|
| 1 | Press with one finger | Vibration |
| 2 | Press with two fingers | Vibration |
| 3 | Press with one palm | No vibration |
| 4 | Press with two palms | No vibration |
| 5 | Press with one palm and | Vibration |
| | one finger | |

As shown in Table 1, by adopting a structure design of surrounding induction layers and stepped protrusion, the processing unit 280 of the present disclosure may drive the force feedback module 290 while the first capacitance changes to saturation and the second capacitance continues changing. For example, in the second touch scenario on the table, when the first capacitance reaches saturation caused by one finger pressing, another finger continuously pressing down may be detected through the detection of the change of the second capacitance, and the processing unit 280 may drive the force feedback module 290 to vibrate. In the fifth touch scenario on the table, when the first capacitance reaches saturation caused by one palm pressing, another finger continuously pressing down may be detected through the detection of the change of the second capacitance, and the processing unit 280 may drive the force feedback module 290 to vibrate. Please note that, in the aforementioned second touch scenario, the pressing positions by two fingers need to be relatively close for the feedback to take effect. By the same token, in the aforementioned fifth touch scenario, the pressing positions of the palm and the finger need to be relatively close for the feedback to take effect.

The processing unit 280 may drive the force feedback module 290 when the first capacitance and the second capacitance are changing simultaneously. For example, in the first touch scenario listed in Table 1, when changes of the first capacitance and the second capacitance caused by pressing with one finger are detected simultaneously, the processing unit 280 may drive the force feedback module 290 to vibrate. Furthermore, the processing unit 280 may not drive the force feedback module 290 when the first capacitance changes to saturation and the second capacitance does not continue changing. For example, in the third touch scenario and the fourth touch scenario listed in Table 1, when the first capacitance changes to saturation and the second capacitance does not continue changing, which are caused by pressing with one palm or two palms, the processing unit 280 does not drive the force feedback module 290 to vibrate. Thus, diverse application combinations are fulfilled, meeting application needs and reducing accidental touches.

In several embodiments, the force feedback module 290 is a linear resonant actuator (LRA); however, the present disclosure is not limited thereto. In other embodiments, the force feedback module 290 may comprise an assembly of separated coil layers and magnet sets, which are disposed on the first capacitive coupling electrode layer 240 and the second substrate 111b, respectively, in order to constitute a vertical vibration module.

In the embodiment as shown in FIG. 3, the quantity of the second capacitance coupling electrode layers 250 disposed on the second substrate 111b is six. However, the present disclosure is not limited thereto, and the quantity may flexibly increase or decrease according to actual needs.

As shown in FIG. 4, in the embodiment, the quantity of the assemblies of the first induction layer 241 and the second induction layer 242 disposed on the first capacitance coupling electrode layer 240 is six. However, the present disclosure is not limited thereto, and the quantity may flexibly increase or decrease according to actual needs.

As shown in FIG. 2 and FIG. 3, in the embodiment, the second substrate 111b has a recess 111b1 on the side close to the support bracket 260. The recess 111b1 is disposed opposite to the support member 270 and a part of the support bracket 260 in the arrangement direction A of the first capacitive coupling electrode layer 240 and the second capacitive coupling electrode layer 250. The design of the recess 111b1 may provide an additional deformation space, so that the support member 270 and the support bracket 260 may undergo deformation more effectively under pressure. Such a design may increase the amount of deformation in the vertical direction (that is, the arrangement direction A) and enhance the capacitive sensing sensitivity.

As shown in FIG. 4, in the embodiment, the support bracket 260 has a hollow portion 261. Please further refer to FIG. 3 showing how the hollow portion 261 is disposed opposite to the recess 111b1 in the arrangement direction A. The hollow portion 261 may allow the touchpad device 200 to undergo deformation more effectively when under pressure, thus enhancing the sensitivity of the touchpad device 200.

In actual applications, the quantity of the hollow portions 261 of the support bracket 260 is not limited to that described in the embodiment as shown in FIG. 4 and may flexibly increase or reduce according to actual needs.

As shown in FIG. 2, in the embodiment, the recess 111b1 has a depth D in the arrangement direction A. The distance S1 between the first protrusion 251 and the first induction layer 241 is larger than the depth D. By such a configuration, it is ensured that when there are no presses, a certain gap between the first protrusion 251 and the first induction layer 241 remains, which may prevent accidental touches. Furthermore, such a design may provide a sufficient deformation space, so that the first protrusion 251 can effectively move closer to the first induction layer 241 while the device is pressed, thus achieving effective capacitive sensing.

In several embodiments, the depth D of the recess 111b1 is about 0.5 mm; however, the present disclosure is not limited thereto.

As shown in FIG. 2, in the embodiment, the first protrusion 251 has a first height H1 in the arrangement direction A. The support member 270 has a second height H2 in the arrangement direction A. The second height H2 is larger than the first height H1. By such a configuration, it is ensured that when not pressed, a certain gap between the first capacitive coupling electrode layer 240 and the second capacitive coupling electrode layer 250 remains (that is, the configuration prevents the first induction layer 241 and the first protrusion 251 from getting too close or contacting one another while the device is not pressed).)

In several embodiments, the first height H1 is about 0.85 mm, and the second height H2 is about 1.0 mm. However, the present disclosure is not limited thereto.

In several embodiments, the support member 270 is made of elastomeric rubber. The Young's modulus of the support member 270 ranges from 0.55 MPa to 0.8 MPa. Please note that if the Young's modulus is too small, the support member 270 may be too soft, causing the touchpad device 200 to become unstable. If the Young's modulus is too large, the support member 270 may be too stiff, resulting in poor hand tactile sense while pressing. According to the embodiments, it can be known that a suitable Young's modulus may ensure that the support member 270 has sufficient flexibility and supporting force, thus providing the optimal hand tactile sense and touch experience.

According to the descriptions of specific embodiments of the present disclosure, it is apparent that, compared to the conventional designs of having a single induction layer, the touchpad device of the present disclosure adopts a design of having surrounding induction layers on the first capacitive coupling electrode layer (that is, a first induction layer and a second induction layer surrounding the first induction layer). Therefore, the present disclosure can detect the touch position and pressure distribution more effectively, which enhances the touch sensing accuracy. Furthermore, the design of the surrounding induction layers helps to distinguish presses in different positions, detecting multi-finger touches or preventing accidental touches. The touchpad device of the present disclosure also adopts a stepped protrusion structure design applied on the second capacitive coupling electrode layer (that is, the first protrusion and the second protrusion have different heights). Therefore, the present disclosure can distinguish different levels of presses and precisely detect presses by fingers, even under the conditions of multi-finger touches or accidental touches. Furthermore, the present disclosure may have the touch sensing element and the first capacitive coupling electrode layer integrated as two layers within a printed circuit board to facilitate thinning the overall design of the touch circuit board.

The above preferred embodiments are presented to disclose the present disclosure and shall not be interpreted to limit the scope, applicability, or configuration of the present disclosure in any way. Those skilled in the art may use any alternative embodiments that are modified or changed without departing from the spirit and scope of the present disclosure. Thus, the protection scope of the present disclosure shall be included in the appended claims.

### COMPONENT SYMBOL

100: Electronic device
110: Host computer
111: Casing part
111a: Recessed groove
111b: Second substrate
111b1: Recess
120: Display
200: Touchpad device
210: First substrate
220: Bonding layer
230: Touch sensing element
231: First touch electrode layer
232: Second touch electrode layer
240: First capacitive coupling electrode layer
241: First induction layer
242: Second induction layer
250: Second capacitive coupling electrode layer
251: First protrusion
252: Second protrusion
260: Support bracket
261: Hollow portion
270: Support member
280: Processing unit
290: Force feedback module
2-2: Line section
A: Arrangement direction
D: Depth
H1: First height
H2: Second height
S1, S2: Distance

What is claimed is:

1. A touchpad device, comprising
a first substrate, having a touch sensing element and a first capacitive coupling electrode layer, wherein the first capacitive coupling electrode layer is configured with a first induction layer and a second induction layer surrounding the first induction layer; and
a second substrate, having a second capacitive coupling electrode layer, wherein the second capacitive coupling electrode layer comprises a first protrusion and a second protrusion surrounding the first protrusion; the first protrusion is higher than the second protrusion; the first protrusion corresponds to the first induction layer; and the second protrusion corresponds to the second induction layer.

2. The touchpad device of claim 1, wherein the first protrusion is disposed opposite to the first induction layer in an arrangement direction of the first capacitive coupling electrode layer and the second capacitive coupling electrode layer; and the second protrusion is disposed opposite to the second induction layer in the arrangement direction.

3. The touchpad device of claim 1, further comprising a processing unit, wherein the processing unit is configured to acquire a first capacitance based on an electrical induction between the first protrusion and the first induction layer; and the processing unit is configured to acquire a second capacitance based on an electrical induction between the second protrusion and the second induction layer.

4. The touchpad device of claim 3, further comprising a force feedback module, wherein the force feedback module is disposed on one side of the first capacitive coupling electrode layer away from the first substrate; and the processing unit is further configured to drive the force feedback module while the first capacitance changes to saturation and the second capacitance continues changing.

5. The touchpad device of claim 4, wherein the processing unit is further configured to drive the force feedback module when the first capacitance and the second capacitance are changing simultaneously.

6. The touchpad device of claim 4, wherein the processing unit is further configured not to drive the force feedback module when the first capacitance changes to saturation and the second capacitance does not continue changing.

7. The touchpad device of claim 1, further comprising:
a support bracket, mounted to the second substrate; and
a support member, disposed between and supporting the support bracket and the first capacitive coupling electrode layer.

8. The touchpad device of claim 7, wherein the second substrate has a recess on a side close to the support bracket; and the recess is disposed opposite to the support member and a part of the support bracket in an arrangement direction of the first capacitive coupling electrode layer and the second capacitive coupling electrode layer.

9. The touchpad device of claim 8, wherein the support bracket comprises at least one hollow portion; and the at least one hollow portion is disposed opposite to the recess in the arrangement direction.

10. The touchpad device of claim 8, wherein the first protrusion and the first induction layer have a distance therebetween in the arrangement direction; the recess has a depth in the arrangement direction; and the distance is larger than the depth.

11. The touchpad device of claim 8, wherein the first protrusion has a first height in the arrangement direction; the support member has a second height in the arrangement direction; and the second height is larger than the first height.

12. The touchpad device of claim 1, wherein the touch sensing element and the first capacitive coupling electrode layer are different conductor layers embedded in a circuit board.
